(19) United States
(12) Patent Application Publication
(10) Pub. No.: US 2026/0292073 A1
(43) Pub. Date: Sep. 24, 2026

(54) IMAGE FORMING APPARATUS, IMAGE READING APPARATUS, AND DETECTION METHOD FOR DEVIATION AMOUNT OF PRINTING POSITION

(71) Applicant: CANON KABUSHIKI KAISHA, Tokyo (JP)

(72) Inventor: KENICHI HIROTA, Ibaraki (JP)

(21) Appl. No.: 19/563,917

(22) Filed: Mar. 11, 2026

(30) Foreign Application Priority Data
Mar. 18, 2025 (JP) 2025-043266

(51) Int. Cl. H04N 1/00

(52) U.S. Cl. CPC H04N 1/00037; H04N 1/00015; H04N 1/00045; H04N 1/00082; H04N 1/00748

(57) ABSTRACT

An image forming apparatus includes a printer configured to print a chart for adjustment on a sheet, a conveyor configured to convey the sheet, a reading sensor configured to read the sheet while the sheet is being conveyed by the conveyor, and output a read image of the sheet, and a controller configured to detect an edge of the sheet from a first detection area of the read image, detect the edge of the sheet from a second detection area different from the first detection area of the read image in a case where the edge is not detected from the first detection area, and adjust an image to be formed on a sheet by the printer based on the detected edge and a reading result of the chart for adjustment.

### BACKGROUND

### Field of the Technology

The present disclosure relates to an image forming apparatus that forms an image on a sheet, an image reading apparatus, and a detection method for a deviation amount of a printing position.

### Description of the Related Art

An image forming apparatus has a function (hereinafter referred to as "printing position adjustment") of adjusting a printing position of an image so that the image is printed at a predetermined position on a paper sheet. With such a function, for example, in a case of performing printing on preprinted paper on which ruled lines or the like have been printed in advance, or in a case of performing duplex printing that requires front-and-back registration, it is possible to achieve high-level printing position alignment.

The printing position adjustment is required to be performed for each type of paper sheet to be used. This is because paper sheets have different conveyance characteristics depending on factors such as a size, a basis weight (weight), and a material, which result in slight differences in printing position. In addition to the type of paper sheet, for example, hygroscopicity of the paper sheet causes a shrinkage rate of the paper sheet to vary due to fixing heat during printing on a front surface (first surface), thereby exerting an influence on a printing position of an image on a back surface (second surface) and a magnification of the image.

In general, the printing position adjustment is performed through use of a "chart for adjustment" in which "predetermined marks" are printed on a paper sheet of a type to be adjusted. Printing position deviation amounts are detected from relative positions of the marks on the chart for adjustment, and are stored as printing parameters for the paper sheet. After that, in a case where printing is performed through use of a paper sheet of the same type as that of the above-mentioned paper sheet, the printing parameters are referred to, and the printing is performed with the printing position adjusted so as to cancel the position deviation amounts, to thereby obtain an output result in which a position deviation has been adjusted. As a method of measuring positions of the marks, there is a method in which an operator measures the positions through use of a ruler or the like and inputs the measured positions to a printing apparatus, but this method requires time and labor, and errors or mistakes due to human measurement may occur, thereby sometimes causing a failure in accurate adjustment. For that reason, there has been proposed a method in which the chart for adjustment is read through use of an image reading apparatus such as a scanner, positions of the marks are automatically detected with high accuracy by analyzing a reading result (read image), and the printing position adjustment is performed.

In a case of using an image reading apparatus, the image reading apparatus is required to read a chart for adjustment with high accuracy. In order to read the chart for adjustment with high accuracy, it is preferred to place the chart for adjustment on a platen. However, in this case, a front surface and a back surface of the chart for adjustment cannot be read at the same time, and hence an adjustment operator is required to manually replace the chart for adjustment, thereby causing an increase in work load. In Japanese Patent Application Laid-open No. 2003-173109, it is described that marks on the front surface and the back surface of a chart for adjustment are read at one time by recognizing marks having a low density that have been read due to show-through as marks on the back surface. In addition, in Japanese Patent Application Laid-open No. 2003-173109, it is also described that marks on both surfaces of a chart for adjustment are read at one time through use of an automatic document conveyance apparatus (hereinafter referred to as "auto document feeder" or "ADF").

In a case of using an ADF to read a chart for adjustment, there is a possibility that marks printed on end portions of the chart for adjustment are not read due to the chart for adjustment being conveyed while being inclined. For example, in a case where the chart for adjustment is conveyed to the outside of an image reading range of the image reading apparatus, the marks printed on the end portions of the chart for adjustment are not read. Further, an ultra-thick paper sheet (having a basis weight of from 300 gsm to 400 gsm) and a paper sheet having a glossy-coated surface, which have been increasingly used in recent years, do not cause the show-through of the marks, and hence it is difficult to read the marks on the back surface of such a paper sheet unlike in Japanese Patent Application Laid-open No. 2003-173109. When the marks of the chart for adjustment are not read as described above, accurate printing position adjustment cannot be performed. Therefore, there is a demand for a technology for reliably reading the chart for adjustment to perform accurate printing position adjustment.

### SUMMARY

An image forming apparatus according to some embodiments of the present disclosure includes a printer configured to print a chart for adjustment on a sheet, a conveyor configured to convey the sheet, a reading sensor configured to read the sheet while the sheet is being conveyed by the conveyor, and output a read image of the sheet, and a controller configured to detect an edge of the sheet from a first detection area of the read image, detect the edge of the sheet from a second detection area different from the first detection area of the read image in a case where the edge is not detected from the first detection area, and adjust an image to be formed on a sheet by the printer based on the detected edge and a reading result of the chart for adjustment.

An image reading apparatus according to some embodiments of the present disclosure includes a reading sensor configured to output a read image obtained by reading a chart for adjustment, and a controller configured to detect an edge of a sheet from a first detection area of the read image, detect the edge of the sheet from a second detection area different from the first detection area of the read image in a case where the edge is not detected from the first detection area, and calculate an adjustment value for an image to be formed onto the sheet based on the detected edge and a reading result of the chart for adjustment.

A detection method for a deviation amount of a printing position to be executed by an image forming apparatus according to some embodiments of the present disclosure includes a printer configured to print a chart for adjustment on a sheet, a conveyor configured to convey the sheet, and a reading sensor configured to read the sheet while the sheet is being conveyed by the conveyor, and output a read image of the sheet, the detection method including detecting an edge of the sheet from a first detection area of the read image, detecting the edge of the sheet from a second detection area different from the first detection area of the read image in a case where the edge is not detected from the first detection area, and adjusting an image to be formed on a sheet by the printer based on the detected edge and a reading result of the chart for adjustment.

A detection method for a deviation amount of a printing position to be executed by an image reading apparatus including a reading sensor configured to output a read image obtained by reading a chart for adjustment according to yet another embodiment of the present disclosure includes detecting an edge of a sheet from a first detection area of the read image, detecting the edge of the sheet from a second detection area different from the first detection area of the read image in a case where the edge is not detected from the first detection area, and calculate the deviation amount of a printing position for an image to be formed onto the sheet based on the detected edge and a reading result of the chart for adjustment.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of a printing system.

FIG. 2 is a configuration diagram of an image forming apparatus.

FIG. 3 is an exemplary view of an edit screen.

FIG. 4 is an exemplary view of a paper sheet attribute edit screen.

FIG. 5 is an explanatory table of a paper sheet library.

FIG. 6 is an explanatory view of a chart for adjustment.

FIG. 7 is an exemplary view of a chart for adjustment in which distinction between front and back surfaces is facilitated.

FIG. 8 is an explanatory view of processing of a reading result of the chart for adjustment.

FIG. 9 is an explanatory table of detection methods for printing position deviation amounts.

FIG. 10 is a flow chart for illustrating acquisition processing for the printing position deviation amounts.

FIG. 11 is an explanatory view of a detection area in a case in which the chart for adjustment deviates in a main scanning direction.

FIG. 12 is a flow chart for illustrating reading processing for the chart for adjustment.

### DESCRIPTION OF THE EMBODIMENTS

Now, referring to the accompanying drawings, description is given of at least one exemplary embodiment of the present disclosure.

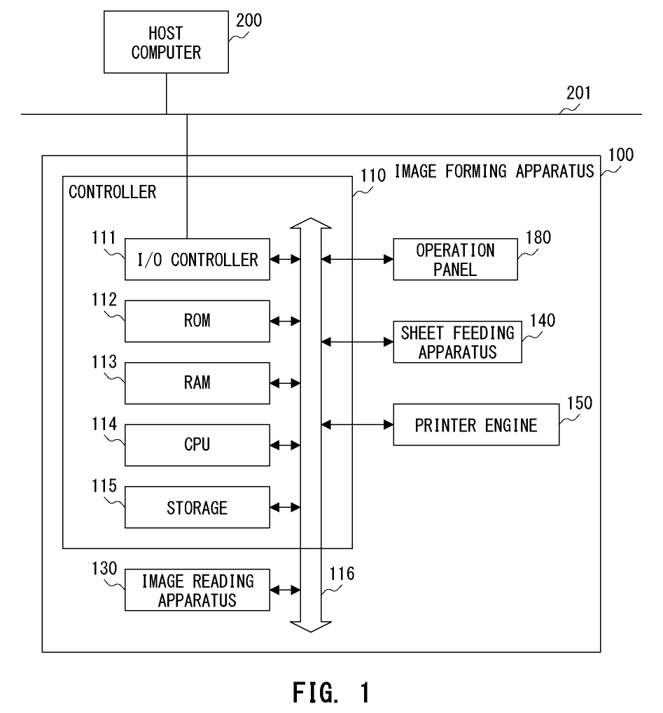

FIG. 1 is an overall configuration diagram of a printing system including an image forming apparatus according to the at least one embodiment. The printing system includes an image forming apparatus 100 and a host computer 200. The image forming apparatus 100 and the host computer 200 are connected to each other so as to enable communication therebetween through a communication line 201. The communication line 201 is, for example, a network line such as a local area network (LAN) or a wide area network (WAN). A plurality of image forming apparatus 100 may be connected to the communication line 201, and a plurality of host computers 200 may also be connected to the communication line 201.

The host computer 200 is, for example, a server, and transmits a print job to the image forming apparatus 100 through the communication line 201. The host computer 200 generates a print job based on information input from, for example, an input device (not shown). The print job includes various kinds of information required for printing, such as image data representing an image (output image) to be printed, a type of paper sheet used for printing, the number of sheets to be printed, and designation of duplex or simplex printing.

The image forming apparatus 100 includes a controller 110, an operation panel 180, a sheet feeding apparatus 140, a printer engine 150, and an image reading apparatus 130. The image forming apparatus 100 forms an image on a paper sheet by the printer engine 150 based on the print job acquired from the host computer 200. The controller 110, the operation panel 180, the sheet feeding apparatus 140, the printer engine 150, and the image reading apparatus 130 are connected to each other through a system bus 116 so as to enable communication therebetween.

The controller 110 performs various kinds of data processing to control each unit of the image forming apparatus 100. The operation panel 180 is a user interface including an input interface and an output interface. The input interface includes operation buttons and a numeric keypad. The output interface includes a display, such as a liquid crystal display (LCD), and a speaker. The operation panel 180 in the at least one embodiment employs a touch panel display. An operator can input a print job, a command, a print setting, and the like to the image forming apparatus 100 through the operation panel 180. The controller 110 acquires the print job, the command, the print setting, and the like input through the operation panel 180. The operation panel 180 can display, under the control of the controller 110, various setting screens and a state of the image forming apparatus 100 on the display.

The image reading apparatus 130 reads an image of an original through use of an optical sensor, and generates read image data as a reading result. The read image data is transmitted to the controller 110. The sheet feeding apparatus 140 includes a plurality of sheet feeding stages that receive paper sheets. The sheet feeding apparatus 140 feeds one sheet at a time in order from the uppermost sheet of a paper sheet bundle that is a bundle of a plurality of paper sheets stacked on each sheet feeding stage. The sheet feeding apparatus 140 conveys, to the printer engine 150, the paper sheet fed from the sheet feeding stage. The printer engine 150 generates a printed matter by printing an image (output image) on the paper sheet supplied from the sheet feeding apparatus 140 based on the image data.

The controller 110 is an information processing device including a read only memory (ROM) 112, a random access memory (RAM) 113, and a central processing unit (CPU) 114. The controller 110 further includes an I/O controller 111 and a storage 115. The storage 115 is a large capacity storage device such as a hard disk drive (HDD) or a solid state drive (SSD).

The I/O controller 111 is a communication interface that controls communication to and from the host computer 200 and another apparatus through the communication line 201. The ROM 112 is a storage device that stores various control programs. The storage 115 stores control programs and various kinds of data such as image data to be used for image forming processing (printing processing). The RAM 113 functions as a system work memory into which the control programs stored in the ROM 112 and the storage 115 are to be loaded. The CPU 114 executes the control programs loaded into the RAM 113 to centrally control the image forming apparatus 100. Modules included in the controller 110 are connected to each other through the system bus 116 so as to enable communication therebetween.

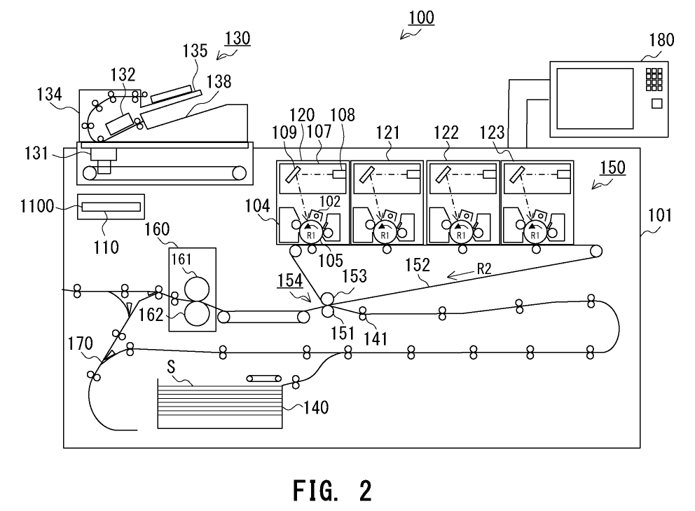

FIG. 2 is a configuration diagram of the image forming apparatus 100. The image forming apparatus 100 incorporates, in a casing 101, respective mechanisms that form the printer engine 150 and a control board housing 1100 that houses the controller 110 that performs control relating to respective printing process operations (for example, sheet feeding processing) performed by the respective mechanisms. The respective mechanisms that form the printer engine 150 include an optical processing mechanism that forms an image and transfers the image onto a paper sheet S, a fixing processing mechanism that fixes the image transferred onto the paper sheet S, and a sheet feeding and conveyance processing mechanism for the paper sheet S.

The optical processing mechanism includes a plurality of image forming units, an intermediate transfer member 152, and a secondary transfer portion 154. The secondary transfer portion 154 includes a secondary transfer inner roller 153 and a secondary transfer roller 151. In the at least one embodiment, in order to print a full-color image by forming images of four colors, namely, yellow (Y), magenta (M), cyan (C), and black (K), four image forming units 120, 121, 122, and 123 are provided so as to correspond to the respective colors. The respective image forming units 120, 121, 122, and 123 have the same configurations and operations, and differ only in color of an image to be formed thereby. In this case, the image forming unit 120 is described.

The image forming unit 120 includes a photosensitive drum 105, a charging device 102, an exposure device 107, and a developing device 104. The photosensitive drum 105 is a drum-shaped photosensitive member including a photosensitive layer on a surface thereof, and is rotated in a direction indicated by an arrow R1 about a drum axis. The charging device 102 uniformly charges the surface of the photosensitive drum 105. The exposure device 107 exposes the uniformly charged surface of the photosensitive drum 105 to laser light, to thereby form an electrostatic latent image on the surface of the photosensitive drum 105. The laser light linearly scans the surface of the photosensitive drum 105 in a drum-axis direction. Thus, the drum-axis direction is a main scanning direction, and a rotation direction of the photosensitive drum 105 intersecting the main scanning direction is a sub-scanning direction.

The exposure device 107 performs drive control of laser light emitted from a light source (not shown) in accordance with image data acquired from the controller 110. The laser light emitted from the light source is reflected by a rotary polygon mirror 108 and a reflection mirror 109 to be guided to the surface of the photosensitive drum 105. In the rotary polygon mirror 108, a reflection surface for the laser light is rotated. As a reflection angle of the laser light changes due to rotation of the rotary polygon mirror 108, the laser light scans the surface of the photosensitive drum 105 in the main scanning direction.

The developing device 104 develops the electrostatic latent image formed on the surface of the photosensitive drum 105 by a developer (in this case, toner), to thereby form a toner image on the surface of the photosensitive drum 105. The toner image on the photosensitive drum 105 is transferred onto the intermediate transfer member 152 to which a voltage having a polarity opposite to that of the toner image is applied. A yellow toner image is transferred from the photosensitive drum 105 of the image forming unit 120 onto the intermediate transfer member 152. A magenta toner image is transferred from the photosensitive drum 105 of the image forming unit 121 onto the intermediate transfer member 152. A cyan toner image is transferred from the photosensitive drum 105 of the image forming unit 122 onto the intermediate transfer member 152. A black toner image is transferred from the photosensitive drum 105 of the image forming unit 123 onto the intermediate transfer member 152.

The intermediate transfer member 152 is an endless belt, is looped around a plurality of rollers including the secondary transfer inner roller 153, and is rotated in a direction indicated by an arrow R2. The toner images of the respective colors are transferred onto a belt surface so as to be superimposed thereon at timings corresponding to rotation of the intermediate transfer member 152. Thus, a full-color toner image is formed on the belt surface of the intermediate transfer member 152. The intermediate transfer member 152 conveys, by being rotated, the transferred toner images of the respective colors to the secondary transfer portion 154.

The paper sheet S is stored on a sheet feeding stage of the sheet feeding apparatus 140 that is the sheet feeding and conveyance processing mechanism. The sheet feeding apparatus 140 conveys the paper sheets S stored on the sheet feeding stage one by one to the secondary transfer portion 154. A registration roller 141 for correcting skew feed of the paper sheet S is provided in a conveyance path from the sheet feeding stage to the secondary transfer portion 154. The registration roller 141 conveys the paper sheet S to the secondary transfer portion 154 in synchronization with a timing at which the toner images borne on the intermediate transfer member 152 are conveyed to the secondary transfer portion 154.

In the secondary transfer portion 154, the paper sheet S is nipped and conveyed while the intermediate transfer member 152 and the paper sheet S are brought into pressure contact with each other by the secondary transfer inner roller 153 and the secondary transfer roller 151. At this time, a bias voltage having a polarity opposite to that of the toner images is applied to the secondary transfer roller 151, and the toner images of the respective colors borne on the intermediate transfer member 152 are thereby collectively transferred onto the paper sheet S.

The paper sheet S onto which the toner image has been transferred is conveyed from the secondary transfer portion 154 to a fixing device 160 that is the fixing processing mechanism. The fixing device 160 includes a fixing roller 161 incorporating a heat source and a pressure roller 162 that is urged toward the fixing roller 161 side. The fixing device 160 nips and conveys the paper sheet S by the fixing roller 161 and the pressure roller 162. At this time, the fixing roller 161 heats the toner by the heat source, and the pressure roller 162 presses the paper sheet S against the fixing roller 161 side. Thus, the toner image is melted and pressure-bonded onto the paper sheet S. The paper sheet S on which the image has been fixed in such a manner is conveyed to the outside of the image forming apparatus 100.

In a case of duplex printing, the paper sheet S on which an image has been formed on one surface (first surface or front surface) is conveyed from the fixing device 160 to a reverser 170. In the reverser 170, the paper sheet S is reversed in a conveyance direction to be conveyed to the secondary transfer portion 154. When the conveyance direction is reversed in the reverser 170, a printing surface of the paper sheet S is switched to the other surface (second surface or back surface). Thus, printing on the back surface of the paper sheet S is performed.

The image forming apparatus 100 includes the operation panel 180 and the image reading apparatus 130, which are described above, on an upper portion of the casing 101. The image reading apparatus 130 includes an ADF 134, and can read an image of an original while automatically conveying the original. The image reading apparatus 130 includes a sheet feeder 135, a first reader 131, a second reader 132, and a sheet discharge portion 138. The originals are placed on the sheet feeder 135, and are fed and conveyed one by one by the ADF 134. The first reader 131 reads an image on one surface (first surface or front surface) of the original being conveyed by the ADF 134. The second reader 132 reads an image on the other surface (second surface or back surface) of the original being conveyed by the ADF 134. The original from which the images have been read is delivered to the sheet discharge portion 138.

The image reading apparatus 130 as described above can read images on both surfaces of an original through a single pass of the original through use of the ADF 134 including the second reader 132. The first reader 131 and the second reader 132 are, for example, optical sensors, and read an image by irradiating the original with light and receiving reflected light therefrom.

### Paper Sheet Library

Paper sheets usable for printing by the image forming apparatus 100 are managed by a database. This database is referred to as "paper sheet library." The paper sheet library is stored in, for example, the host computer 200 (server) connected to the image forming apparatus 100 or the storage 115. Information on each paper sheet stored in the paper sheet library is read out therefrom or written thereto as required.

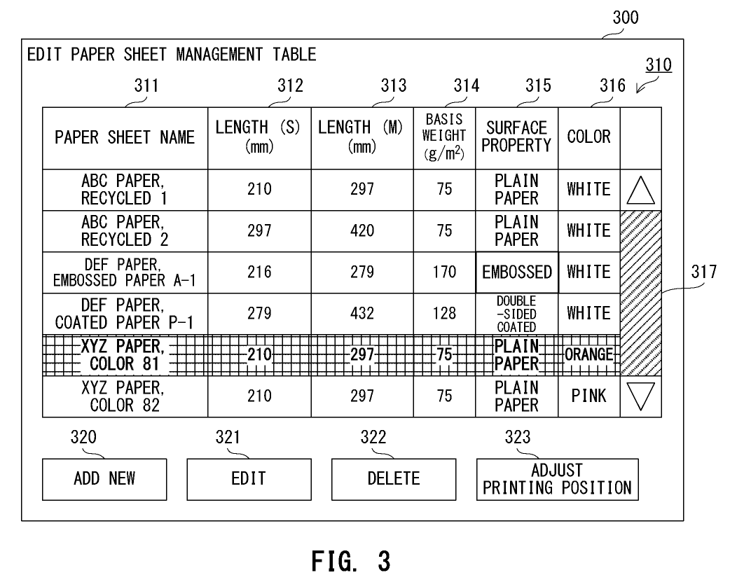

FIG. 3 is an exemplary view of an edit screen for the operator to edit the information on the paper sheet stored in the paper sheet library. An edit screen 300 is displayed on the display of the operation panel 180 of the image forming apparatus 100. The edit screen 300 includes a paper sheet list 310, an add new button 320, an edit button 321, a delete button 322, and a printing position adjustment button 323.

A list of paper sheets managed by a paper sheet library 600 is displayed in the paper sheet list 310. Attribute information indicating characteristics of each paper sheet is displayed in columns 311 to 316. A paper sheet name is displayed in the column 311. The paper sheet name is information set by the operator so that the type of the paper sheet can be identified. A paper sheet size is displayed in the columns 312 and 313. A paper sheet length in the sub-scanning direction (“LENGTH (S)” in FIG. 3) is displayed in the column 312, and a paper sheet length in the main scanning direction (“LENGTH (M)” in FIG. 3) is displayed in the column 313. A basis weight of the paper sheet is displayed in the column 314.

Information for identification of a surface property of the paper sheet is displayed in the column 315. The information for identification of the surface property of the paper sheet is information on a physical characteristic of a paper sheet surface. For example, the paper sheet displayed as "DOUBLE-SIDED COATED" in the column 315 refers to a paper sheet subjected to surface treatment for increasing glossiness. The paper sheet displayed as "EMBOSSED" in the column 315 refers to a paper sheet subjected to unevenness processing. The paper sheet displayed as "PLAIN PAPER" in the column 315 refers to a paper sheet that has not been subjected to special processing. A color of the paper sheet is displayed in the column 316.

To edit the information on the paper sheet, the operator selects a paper sheet (paper sheet name) for which the information is to be edited from the paper sheet list 310 displayed on the operation panel 180. A method of displaying the selected paper sheet is changed so that the selected paper sheet can be distinguished from unselected paper sheets. For example, the selected paper sheet is displayed in highlight display (inverted display) as compared to the unselected paper sheets. In FIG. 3, as an example, "XYZ PAPER, COLOR 81" is selected. In this case, a row of "XYZ PAPER, COLOR 81" is displayed by a method different from a method of displaying rows of the other unselected paper sheets. When the number of paper sheets managed in the paper sheet library is larger than the number of paper sheets that can be displayed in the paper sheet list 310 at a time, the operator can select another sheet by operating a scroll bar 317.

The add new button 320 is a button for newly adding information on the paper sheet to the paper sheet library 600. The edit button 321 is a button for editing the information on the paper sheet selected from the paper sheet list 310. The delete button 322 is a button for deleting the information on the paper sheet selected from the paper sheet list 310 from the paper sheet library 600. The printing position adjustment button 323 is a button for performing printing position adjustment on the paper sheet selected from the paper sheet list 310.

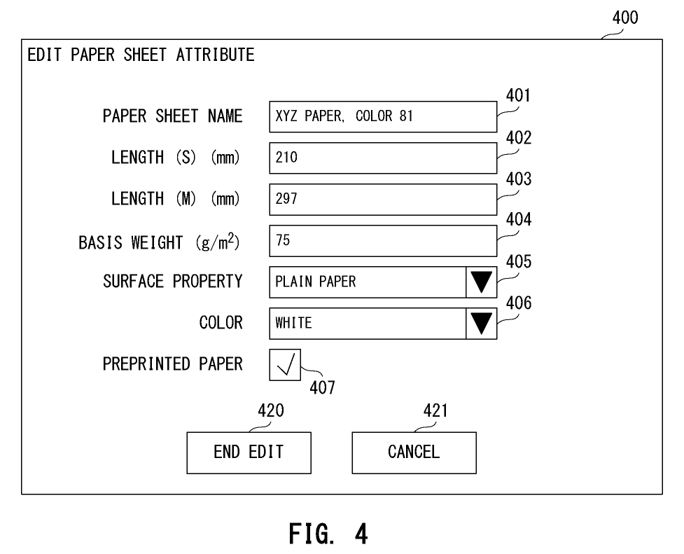

When the add new button 320 or the edit button 321 on the edit screen 300 is pressed, a paper sheet attribute edit screen for inputting information on a paper sheet is displayed on the operation panel 180. FIG. 4 is an exemplary view of the paper sheet attribute edit screen. A paper sheet attribute edit screen 400 includes text boxes 401 to 404, combo boxes 405 and 406, a checkbox 407, an end edit button 420, and a cancel button 421.

The text box 401 is an input area for the paper sheet name. The text box 402 is an input area for the paper sheet length in the sub-scanning direction ("LENGTH (S)" in FIG. 4). The text box 403 is an input area for the paper sheet length in the main scanning direction ("LENGTH (M)" in FIG. 4). The text box 404 is an input area for the basis weight of the paper sheet. The input to each of the text boxes 401 to 404 is performed through use of a software keyboard or the operation panel 180.

The combo box 405 is an area for designating the surface property of the paper sheet. The operator designates the surface property of the paper sheet from among a plurality of types of surface properties. Information on the plurality of types of surface properties is registered in advance, and the surface property is designated from a list displayed in a pull-down manner. The combo box 406 is an area for designating the color of the paper sheet. The operator designates the color of the paper sheet from among a plurality of colors. Information on the plurality of colors is registered in advance, and the color is designated from a list displayed in a pull-down manner. The checkbox 407 is a designation area for designating whether or not the paper sheet is preprinted paper. When the paper sheet is preprinted paper, the operator checks the checkbox 407.

The end edit button 420 is a button for saving the information on the paper sheet, which has been input to the paper sheet attribute edit screen 400, to the paper sheet library 600. When the end edit button 420 is pressed, the information on the paper sheet that has been input up to that time point is confirmed and saved to the paper sheet library 600. After the information on the paper sheet has been saved to the paper sheet library 600, the paper sheet attribute edit screen 400 is switched to the edit screen 300 of FIG. 3. The cancel button 421 is a button for transitioning to the edit screen 300 of FIG. 3 without saving the information on the paper sheet, which has been input to the paper sheet attribute edit screen 400, to the paper sheet library 600. When the cancel button 421 is pressed, the editing of the information on the paper sheet is canceled.

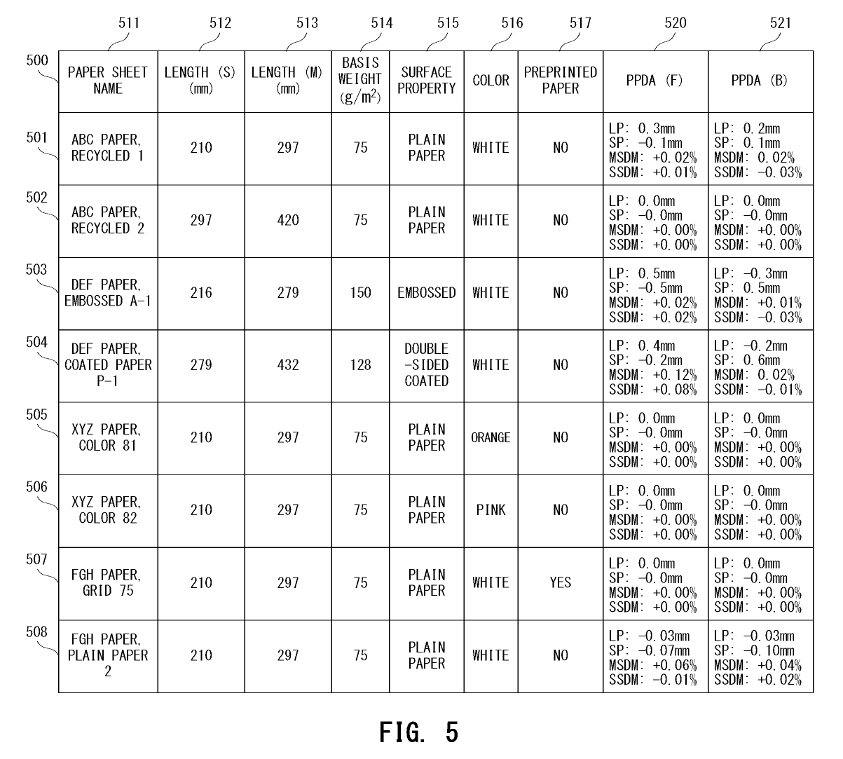

FIG. 5 is an explanatory table of the paper sheet library. The paper sheet library 600 is saved as digital information. The digital information as used herein refers to information described through use of, for example, extensible markup language (XML) or comma-separated values (CSV).

Rows 501 to 508 indicate the information on paper sheets registered in the paper sheet library 600. Columns 511 to 517 indicate sheet attributes. The column 511 indicates a name of each paper sheet. The columns 512 to 515 indicate the physical characteristics of the paper sheet. The column 512 indicates the paper sheet length in the sub-scanning direction ("LENGTH (S)" in FIG. 5) of the paper sheet, the column 513 indicates the paper sheet length in the main scanning direction ("LENGTH (M)" in FIG. 5) of the paper sheet, the column 514 indicates the basis weight of the paper sheet, and the column 515 indicates the surface property of the paper sheet. The column 516 indicates the color of the paper sheet. The column 517 indicates whether or not the paper sheet is preprinted paper.

In column 520, “PPDA (F)” indicates printing position deviation amounts on the front surface of each paper sheet. In column 521, “PPDA (B)” indicates printing position deviation amounts on the back surface of each paper sheet. The printing position deviation amount is a value that quantitatively represents a deviation between an actual printing position, which has been obtained from the reading result of each image for adjustment, and an ideal printing position. In the at least one embodiment, the printing position deviation amounts are represented by printing parameters such as a lead position, a side position, a main-scanning-direction magnification, and a sub-scanning-direction magnification.

The lead position (“LP” in FIG. 5) represents a printing position deviation amount in the sub-scanning direction with respect to the paper sheet. The side position (“SP” in FIG. 5) represents a printing position deviation amount in the main scanning direction with respect to the paper sheet. The lead position is adjusted by changing a printing start position of the image with the leading end of the paper sheet being set as a starting point in the conveyance direction of the paper sheet S. The side position is adjusted by changing a printing start position of the image with an end portion of the paper sheet parallel to the conveyance direction of the paper sheet S being set as a starting point. Specifically, the lead position and the side position are adjusted by adjusting a laser light exposure start timing for the exposure device 107 to start to expose the photosensitive drum 105 to laser light. For example, the CPU 114 controls the exposure device 107 to adjust the laser light exposure start timing.

The sub-scanning-direction magnification (“SSDM” in FIG. 5) represents a deviation (magnification) of a length of an actual printing area in the sub-scanning direction from an ideal length in the sub-scanning direction. Specifically, the sub-scanning-direction magnification is adjusted by controlling a rotation speed of the photosensitive drum 105 or the rotation speed of the intermediate transfer member 152. For example, the CPU 114 adjusts a magnification in the sub-scanning direction by adjusting a rotation speed of a motor (not shown) that rotates the photosensitive drum 105 or a motor (not shown) that rotates the intermediate transfer member 152.

The main-scanning-direction magnification (“MSDM” in FIG. 5) represents a deviation (magnification) of a length of an actual printing area in the main scanning direction from an ideal length in the main scanning direction. Specifically, the main-scanning-direction magnification is adjusted by controlling a clock frequency of the laser light in a case where the exposure device 107 modulates the laser light based on the image data. For example, the CPU 114 controls the exposure device 107 to control the clock frequency. In another case, the CPU 114 may perform image processing on the image data so that the printing position of the output image becomes an ideal printing position. Image processing for causing the printing position of the output image to become an ideal printing position is image processing such as, for example, affine transformation.

When an output image is printed on a paper sheet based on a print job, the controller 110 adjusts the printing position based on the printing position deviation amount so that the image is to be printed at an ideal position on the paper sheet. The controller 110 refers to the printing position deviation amount in the paper sheet library 600 to perform the image processing on the image data so that the printing position becomes an ideal printing position. For example, the controller 110 corrects the printing position of the image formed based on image data to the ideal printing position through the affine transformation. The controller 110 controls the printer engine 150 to print the image on the paper sheet based on the image data subjected to image processing.

An initial value of each item of the printing position deviation amount is "0". When a paper sheet is newly registered in the paper sheet library 600 or when the paper sheet has been registered but the printing position adjustment has not been performed, the initial value is used as the printing position deviation amount. Those printing position deviation amounts are acquired through detection of positions of marks from a chart for adjustment in which predetermined marks are arranged. The chart for adjustment is created by causing the image forming apparatus 100 to print the marks on the paper sheet S.

### Chart for Adjustment

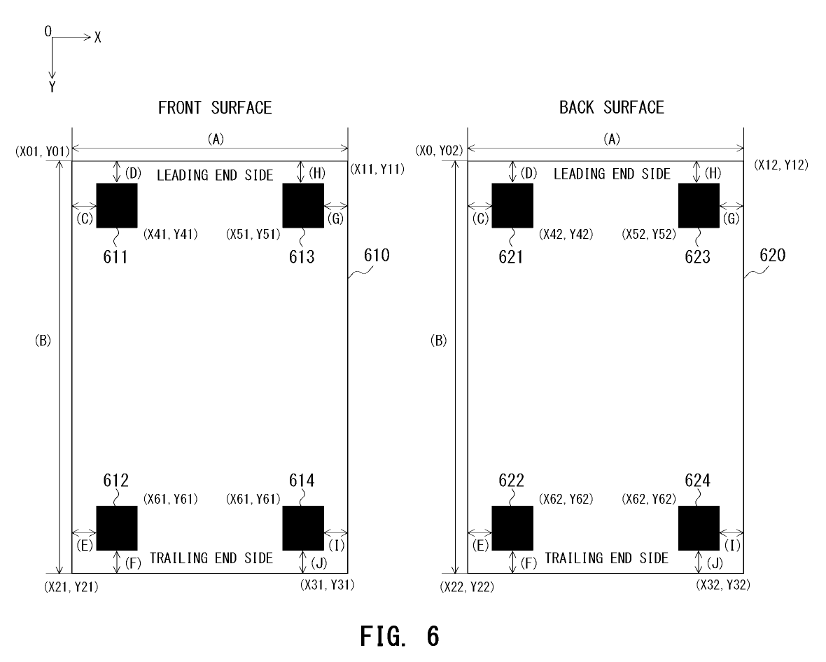

FIG. 6 is an explanatory view of a chart for adjustment. The image forming apparatus 100 creates the chart for adjustment by printing an image 610 for adjustment on the front surface of the paper sheet S and printing an image 620 for adjustment on the back surface of the paper sheet S. The images 610 and 620 for adjustment include a plurality of marks 611 to 614 and 621 to 624 for printing position correction, respectively. The marks 611 to 614 and 621 to 624 are printed in four corners of the paper sheet S at positions spaced apart from paper sheet ends by predetermined distances. The plurality of marks 611 to 614 and 621 to 624 are formed through use of black toner at the same image density. Printing in black increases a difference between intensity of light reflected by the marks 611 to 614 and 621 to 624 and intensity of light reflected by the paper sheet S. Thus, it is possible to detect contours of the marks 611 to 614 and 621 to 624 with high accuracy from the reading result obtained by the image reading apparatus 130.

When the printing positions are ideal positions, distances from paper sheet ends to the respective marks 611 to 614 and 621 to 624 are predetermined distances defined in advance. That is, ideally, the marks 611 to 614 and 621 to 624 are printed at positions spaced apart from four sides of the paper sheet S by fixed distances. In order to detect deviation amounts of the printing positions, the controller 110 measures positions of the marks 611 to 614 and 621 to 624 on the paper sheet. The controller 110 measures lengths (C) through (J) shown in FIG. 6 based on the reading results (read images) of the images for adjustment obtained by the image reading apparatus 130. The lengths (C) through (J) are distances from respective sides of the marks 611 to 614 and 621 to 624 to nearest end portions (sides) of the paper sheet S. The deviation amounts of the printing positions are derived based on differences between the lengths (C) through (J) that have been actually measured and corresponding lengths (C) through (J) that are exhibited in a case where the respective marks 611 to 614 and 621 to 624 are printed at ideal positions.

Coordinates of vertices of the respective marks 611 to 614 and 621 to 624 can also be acquired based on reading results (read images) of the marks 611 to 614 and 621 to 624. In FIG. 6, coordinates of vertices of the respective marks 611 to 614 and 621 to 624 on sides opposite to vertices located at four corners of the paper sheet S are illustrated as an example. A skew-feed degree, a right-angle degree, a trapezoidal degree, and the like may be detected based on the reading results (read images) of the respective marks 611 to 614 and 621 to 624. The skew-feed degree represents a degree of parallelism of the marks 611 to 614 and 621 to 624 with respect to a predetermined one side of the rectangular paper sheet S. The right-angle degree represents a degree of rectangularity of the marks 611 to 614 and 621 to 624 printed on the paper sheet S. The trapezoidal degree represents a degree of parallelism of opposing sides of the marks 611 to 614 and 621 to 624 printed on the paper sheet S.

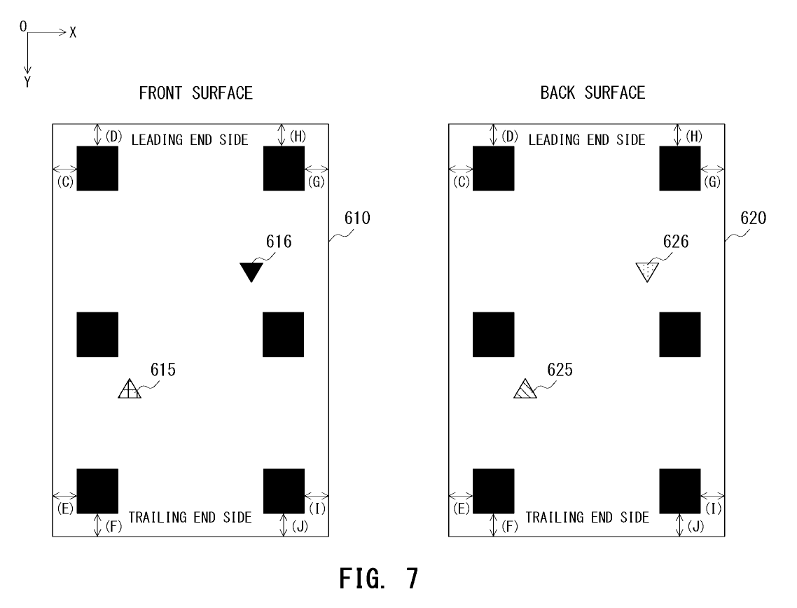

The marks 611 to 614 and 621 to 624 are printed at similar positions, and hence it is difficult for an operator to distinguish between the front surface and the back surface of the chart for adjustment. FIG. 7 is an exemplary view of a chart for adjustment in which distinction between front and back surfaces is facilitated. In the chart for adjustment of FIG. 7, different indicators 615, 616, 625, and 626 are printed on the front surface and the back surface. The indicators 615, 616, 625, and 626 enable the operator to distinguish between the front surface and the back surface of the chart for adjustment.

### READING OF CHART FOR ADJUSTMENT

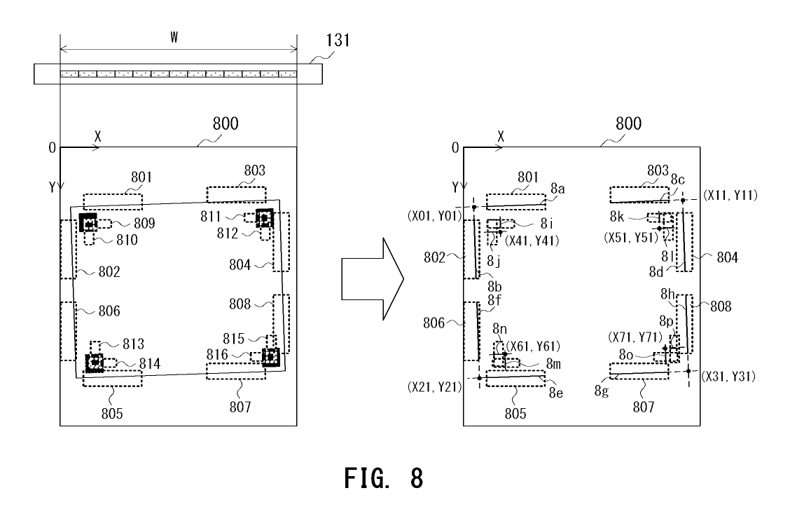

FIG. 8 is an explanatory view of processing of a reading result (read image) of the chart for adjustment. In FIG. 8, a read image of the front surface of the chart for adjustment that has been read by the first reader 131 of the image reading apparatus 130 is illustrated.

In the at least one embodiment, the chart for adjustment is placed on the sheet feeder 135 of the ADF 134. The image reading apparatus 130 reads the images from the chart for adjustment that is being conveyed. For that reason, measurement accuracy is lower than that in a case in which the chart for adjustment is placed on a platen. In the at least one embodiment, in order to improve the measurement accuracy, a plurality of charts for adjustment are read, and printing position adjustment is performed through use of average values of measurement results (positions) of the marks 611 to 614 and 621 to 624 obtained from a plurality of reading results (read images). Even in this case, the operator can perform printing position adjustment work without an increase in work load.

The plurality of charts for adjustment placed on the sheet feeder 135 are sequentially fed one by one, and after having the front surface read by the first reader 131 and the back surface read by the second reader 132, are delivered to the sheet discharge portion 138. The reading result (read image) of the front surface and the reading result (read image) of the back surface are subsequently processed in the same manner, and hence the subsequent processing is described below by taking the read image of the front surface as an example.

The read image data representing the read image is loaded, for example, into an image memory 800 formed in the RAM 113. In FIG. 8, an X direction is the main scanning direction, and a Y direction is the sub-scanning direction (conveyance direction of the chart for adjustment at a time of reading). The main scanning direction is a direction of lines to be followed in a case where the first reader 131 reads the image line by line. Detection areas 801 to 808, which are rectangular areas indicated by the broken lines, are areas for detecting end portions of the chart for adjustment. Detection areas 809 to 816, which are rectangular areas indicated by the broken lines, are areas for detecting end portions of the marks 611 to 614 and 621 to 624.

Arrangement of the detection areas 801 to 816 is generally determined, after marks serving as a reference are primarily detected, at positions shifted by predetermined distances from the marks. This is because positional variations of an inspection target are to be handled. In the at least one embodiment, the detection areas 801 to 816 are arranged at positions spaced apart by predetermined distances so as to include the end portions of the chart for adjustment, with the ideal positions of the marks 611 to 614 and 621 to 624 taken as a reference. In FIG. 8, the chart for adjustment is in an inclined orientation with respect to an array (main scanning direction) of light receivers of the first reader 131 due to influences of a placement error on the sheet feeder 135 and an error in the conveyance direction. However, the end portions of the chart for adjustment and the end portions of the marks 611 to 614 and 621 to 624 on all upper, lower, left, and right sides fall within the detection areas 801 to 816.

Processing for extraction of an end portion is performed within each of the detection areas 801 to 816. Extraction of an end portion of the chart for adjustment is performed by, for example, detecting a change in brightness value between a background part and a paper sheet part in the read image. Extraction of an end portion of each mark is performed by, for example, detecting a change in brightness value between the paper sheet part and the mark in the read image.

In the detection areas 801 to 808, the end portions of the chart for adjustment are extracted, and straight lines 8a to 8h, which are obtained by converting the end portions into first-order linear equations, are obtained. In the detection areas 809 to 816, respective end portions of the marks 611 to 614 and 621 to 624 are extracted, and straight lines 8i to 8p, which are obtained by converting the end portions into first-order linear equations, are obtained. Through use of those straight lines 8a to 8p, coordinates of end portions and corner portions (vertices) of the paper sheet of the chart for adjustment and coordinates of corner portions (vertices) of the marks 611 to 614 and 621 to 624 are obtained.

For example, in an upper left part, coordinates (X01, Y01) of an upper left corner portion of the chart for adjustment are extracted as an intersection point between the straight line 8a and the straight line 8b. Coordinates (X41, Y41) of a lower right corner portion of the mark 611 at the upper left are extracted as an intersection point between the straight line 8i and the straight line 8j. The same processing is performed for an upper right portion, a lower left portion, and a lower right portion. As a result, coordinates (X11, Y11) of an upper right corner portion of the chart for adjustment and coordinates (X51, Y51) of a lower left corner portion of the mark 613 at the upper right are obtained. Coordinates (X21, Y21) of a lower left corner portion of the chart for adjustment and coordinates (X61, Y61) of an upper right corner portion of the mark 612 at the lower left are obtained. Coordinates (X31, Y31) of a lower right corner portion of the chart for adjustment and coordinates (X71, Y71) of an upper left corner portion of the mark 614 at the lower right are obtained.

In the same manner, coordinates of respective corner portions (vertices) of the marks 611 to 614 and straight lines of end portions thereof are obtained. Actually measured values of the lengths (A) through (J) shown in FIG. 6 are obtained through use of the coordinates of the respective corner portions (vertices) of the chart for adjustment and the straight lines of the end portions thereof, and the coordinates of the respective corner portions (vertices) of the marks 611 to 614 and the straight lines of the end portions thereof.

### Printing Position Deviation Amount

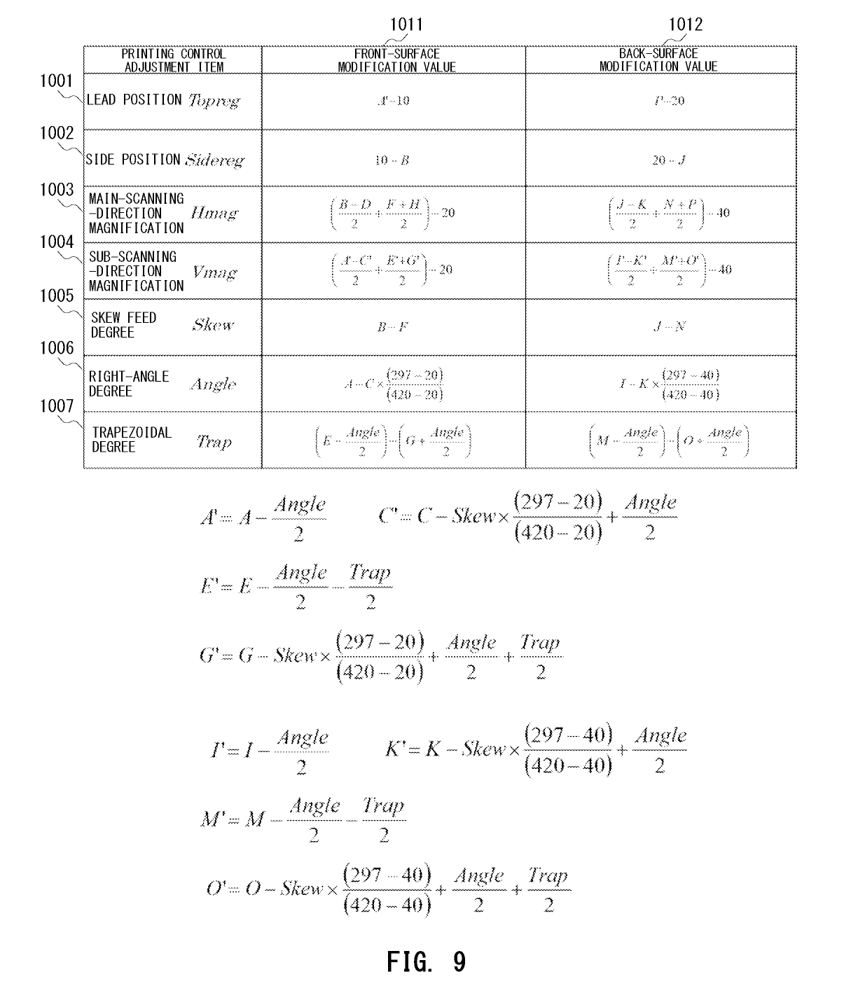

FIG. 9 is an explanatory table of detection methods for printing position deviation amounts. The printing position deviation amounts are obtained based on the actually measured values of the lengths (A) through (J), which have been measured from the reading results (read images) of the chart for adjustment. Items 1001 to 1007 are respective items representing the printing position deviation amounts. In this case, the skew-feed degree, the right-angle degree, and the trapezoidal degree are added to the items of the printing position deviation amounts shown as an example in the paper sheet library of FIG. 5. The respective items 1001 to 1007 are correction values (modification values) of the printing position deviations that are calculated for each of the front surface (front-surface modification values 1011) and the back surface (back-surface modification values 1012).

In the at least one embodiment, values of the respective items 1001 to 1007 are calculated so that the marks 611 to 614 and 621 to 624 are printed at ideal positions spaced apart from end portions of the paper sheet by predetermined distances. Even when the paper sheet S does not have a rectangular shape or when the paper sheet S has an inaccurate size (length in the main scanning direction and length in the sub-scanning direction), adjustment results are calculated so that margins on the four sides of the paper sheet are constant in accordance with the shape of the paper sheet used for the chart for adjustment. The images on the front surface and the back surface are read at the same time to perform calculation so that amounts of the margins on the four sides on the front surface and the back surface have the same values, and hence it is possible to detect the printing positions of the marks 611 to 614 and 621 to 624 with high accuracy without being influenced by paper sheet expansion and contraction due to a reading time difference between the front surface and the back surface. Thus, it is possible to perform front-and-back registration adjustment with high accuracy.

### Adjustment Processing for Printing Position Deviation

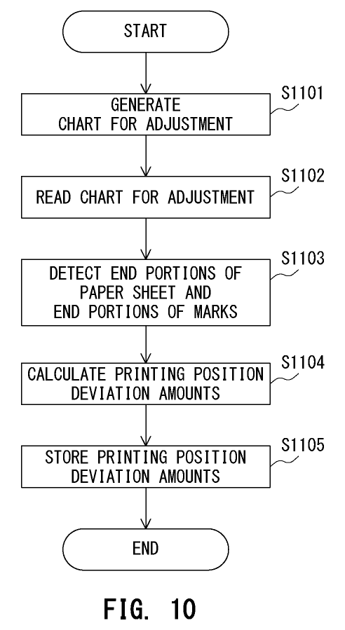

FIG. 10 is a flow chart for illustrating acquisition processing for the printing position deviation amounts. The operator selects one paper sheet for which printing position deviation amounts are to be acquired from the edit screen 300 illustrated as an example in FIG. 3, and presses the printing position adjustment button 323. The CPU 114 acquires, from the operation panel 180, content input through such an operation performed by the operator, and thereby starts the acquisition processing for the printing position deviation amounts.

The CPU 114 controls the printer engine 150 to form the images 610 and 620 for adjustment illustrated as an example in FIG. 6 on both surfaces of a paper sheet of a type selected through the edit screen 300, to thereby generate a chart for adjustment (Step S1101). The generated chart for adjustment is delivered to the outside of the image forming apparatus 100. The operator places the delivered chart for adjustment on the sheet feeder 135 of the image reading apparatus 130.

After the operator places the chart for adjustment, the operator uses the operation panel 180 to issue an instruction to read the chart for adjustment. In response to the instruction, the CPU 114 controls operations of the image reading apparatus 130 to read the images 610 and 620 for adjustment printed on both surfaces of the chart for adjustment (Step S1102). As described above, the image reading apparatus 130 includes the first reader 131 and the second reader 132, and hence the reading of the images 610 and 620 for adjustment is performed by the ADF 134 conveying the chart for adjustment only once. Thus, a work amount of the operator for reading the chart for adjustment is reduced.

The CPU 114 analyzes the read images, which are reading results of the chart for adjustment, as described above to detect the end portions and corner portions of the chart for adjustment and the end portions and corner portions of the marks 611 to 614 and 621 to 624 (Step S1103). The CPU 114 measures the lengths (A) through (J) on each of the front surface and the back surface based on the detected end portions and corner portions of the chart for adjustment and the detected end portions and corner portions of the marks 611 to 614 and 621 to 624. The CPU 114 calculates the values of the respective items of the printing position deviation amounts through use of calculation formulae shown as an example in FIG. 10 based on the measurement results of the lengths (A) through (J) (Step S1104). The CPU 114 stores the calculated printing position deviation amounts in the paper sheet library as the printing position deviation amounts for the paper sheet selected on the edit screen 300 (Step S1105). Accordingly, the acquisition processing for the printing position deviation amounts is ended.

### Processing for Extraction of End Portion in Case in which Chart for Adjustment Deviates

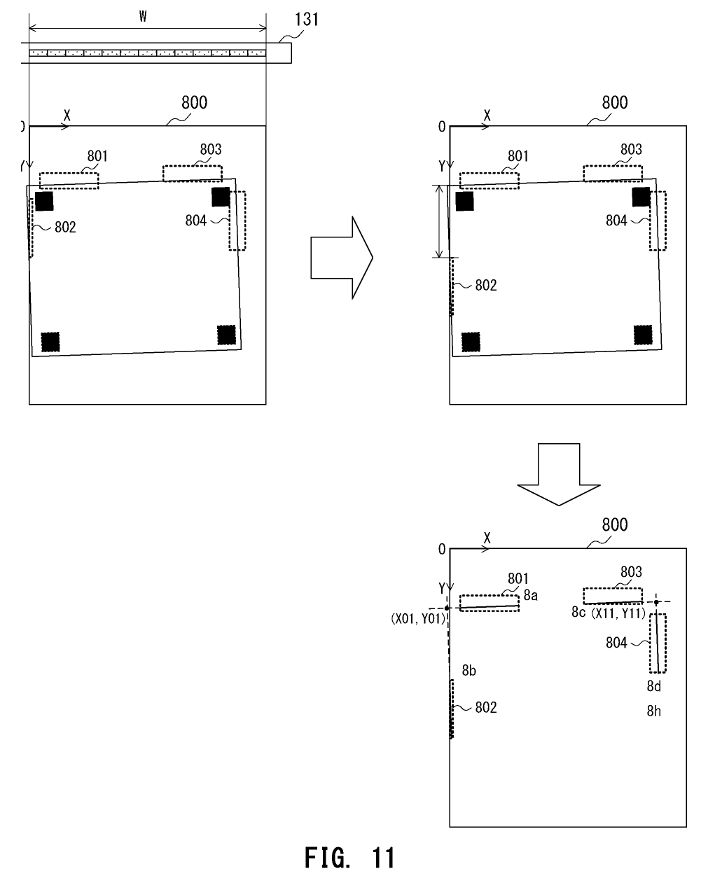

FIG. 11 is an explanatory view of a detection area in a case in which, at the time of reading the chart for adjustment, the chart for adjustment deviates in a negative direction of the X-axis (main scanning direction) with respect to an effective reading width W of a reader (in this case, the first reader 131). When only one sheet of copy paper lacking stiffness, such as thin coated paper, is set for the chart for adjustment placed on the sheet feeder 135 of the ADF 134, there is a possibility that the position of the chart for adjustment greatly deviates with respect to the effective reading width W in such a manner.

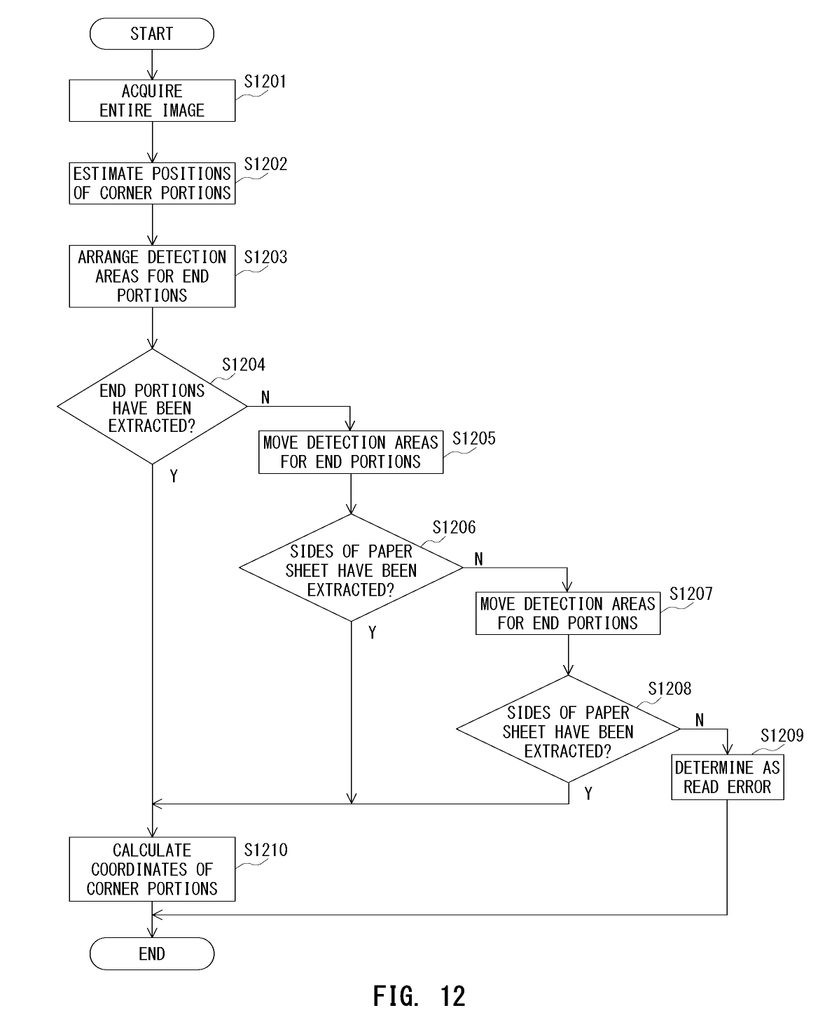

In the case of FIG. 11, the detection area 802 is set to extend out of the effective reading width W, that is, out of the image memory 800. For that reason, a read image in an extended portion becomes unable to be detected. In the at least one embodiment, in this case, the detection area 802 is moved to enable detection of a paper sheet end portion. FIG. 12 is a flow chart for illustrating reading processing for the chart for adjustment of Step S1102 of FIG. 10 in the above-mentioned case.

The CPU 114 acquires an entire image of the read image (Step S1201). The CPU 114 estimates rough positions of the marks and rough positions of the corner portions of the paper sheet (chart for adjustment) based on the acquired entire image of the image for adjustment (Step S1202). In this case, the entire image of the read image acquired by the CPU 114 may be a simplified image such as, for example, a thumbnail image. This is because it suffices that the rough positions of the marks and the rough positions of the corner portions of the paper sheet can be estimated. The CPU 114 arranges the detection areas 801 to 808 for searching for the end portions of the paper sheet at positions spaced apart from the estimated positions of the corner portions of the paper sheet by predetermined distances (Step S1203).

The CPU 114 determines whether or not the end portions of the paper sheet or the like can be extracted from within the detection areas (detection areas 801 to 808) (Step S1204). When the extraction is possible (Y in Step S1204), the CPU 114 calculates the coordinates of the corner portions of the paper sheet (Step S1210). When the extraction is not possible (N in Step S1204), the CPU 114 rearranges the positions of the detection areas 801 to 808 to positions spaced further apart from the estimated positions of the corner portions of the paper sheet (Step S1205).

The CPU 114 determines whether or not the end portions of the paper sheet or the like can be extracted from within the rearranged detection areas (detection areas 801 to 808) (Step S1206). When the extraction is possible (Y in Step S1206), the CPU 114 calculates the coordinates of the corner portions of the paper sheet (Step S1210). When the extraction is not possible (N in Step S1206), the CPU 114 rearranges the positions of the detection areas 801 to 808 again to positions spaced further more apart from the estimated positions of the corner portions of the paper sheet (Step S1207). That is, each time the positions of the detection areas 801 to 808 are rearranged, the positions of the detection areas 801 to 808 become more farther away from the estimated positions of the corner portions of the paper sheet.

The CPU 114 determines whether or not the end portions of the paper sheet or the like can be extracted from within the detection areas (detection areas 801 to 808) rearranged again (Step S1208). When the extraction is possible (Y in Step S1208), the CPU 114 calculates the coordinates of the corner portions of the paper sheet (Step S1210). When the extraction is not possible (N in Step S1208), the CPU 114 determines that there has occurred a read error in which the entire chart for adjustment cannot be read due to a deviation of the chart for adjustment in the main scanning direction being large, and ends the processing (Step S1209). In this case, the image reading apparatus 130 stops reading the chart for adjustment.

It is possible to prevent degradation in detection accuracy by resetting the detection areas so as to be spaced apart from the corner and end portions of the chart for adjustment by predetermined distances in the above-mentioned manner. Further, even when the chart for adjustment greatly deviates with respect to the effective reading width W of the image reading apparatus 130, it is possible to improve a reading success rate of the chart for adjustment.

In the at least one embodiment, a configuration in which the image reading apparatus 130 is provided on the upper portion of the casing 101 of the image forming apparatus 100 has been described. In addition, the image reading apparatus 130 may be an in-line image sensor provided downstream of the fixing device 160 in the conveyance direction of the paper sheet S. In this case, the paper sheet to which an image for adjustment has been fixed by the fixing device 160 is read by the in-line image sensor before being delivered to the outside of the image forming apparatus 100. In this case, the operator is no longer required to place the delivered chart for adjustment on the sheet feeder 135 of the image reading apparatus 130, and hence a load on the operator is further reduced.

The image reading apparatus 130 may also be used independently of the image forming apparatus 100 as a single unit. In this case, calculation processing for the printing position deviation amounts (Step S1102 to Step S1104 of FIG. 8) may be performed in the image reading apparatus 130. In this case, the image reading apparatus 130 includes a processor that performs the calculation processing for the printing position deviation amounts. The calculated printing position deviation amounts are stored in the image forming apparatus 100. In another case, the calculated printing position deviation amounts are stored in, for example, the host computer 200, and are read out to the image forming apparatus 100 in a case where the image forming apparatus 100 is to form an image on the paper sheet S. In this case, the image reading apparatus 130 is connected to the communication line 201, and performs communication through the communication line 201. The image reading apparatus 130 transmits the calculated printing position deviation amount to the image forming apparatus 100 or the host computer 200 as an adjustment value of the image. The image forming apparatus 100 prints, on the paper sheet S, the image having a printing position adjusted according to the adjustment value.

In a case in which the detection areas are moved and rearranged, detection areas before and after the movement are only required to include at least a partially different area. For example, (1) the detection areas before and after the movement do not overlap at all, (2) the detection areas before and after the movement partially overlap, or (3) the detection area after the movement is larger than the detection area before the movement. In any case, the rearranged detection area after the movement is only required to include an area other than the detection area before the movement. In the same manner, in a case in which the detection areas are rearranged again, the detection area rearranged again is only required to include at least a partially different area from a combined area of both the initial detection area and the second detection area.

According to the present disclosure as described above, it is possible to reliably read the chart for adjustment to perform accurate printing position adjustment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-043266, filed March 18, 2025, which is hereby incorporated by reference herein in its entirety.

What is claimed is:

1. An image forming apparatus comprising:
a printer configured to print a chart for adjustment on a sheet;
a conveyor configured to convey the sheet;
a reading sensor configured to read the sheet while the sheet is being conveyed by the conveyor, and output a read image of the sheet; and
a controller configured to:
detect an edge of the sheet from a first detection area of the read image;
detect the edge of the sheet from a second detection area different from the first detection area of the read image in a case where the edge is not detected from the first detection area; and
adjust an image to be formed on a sheet by the printer based on the detected edge and a reading result of the chart for adjustment.

2. The image forming apparatus according to claim 1, wherein the controller is configured to detect an edge of the sheet extending in a direction intersecting a conveyance direction in which the conveyor conveys the sheet.

3. The image forming apparatus according to claim 2,
wherein the controller is configured to further detect an edge of the sheet extending in the conveyance direction, and
wherein the controller is configured to adjust an image to be formed on a sheet by the printer based on the edge of the sheet extending in the conveyance direction, the edge of the sheet extending in the direction intersecting the conveyance direction, and the reading result of the chart for adjustment.

4. The image forming apparatus according to claim 3,
wherein the controller is configured to further determine a corner portion of the sheet from the read image based on the edge of the sheet extending in the conveyance direction and the edge of the sheet extending in the direction intersecting the conveyance direction, and
wherein the controller is configured to adjust an image to be formed on a sheet by the printer based on the corner portion and the reading result of the chart for adjustment.

5. The image forming apparatus according to claim 3, wherein the controller is configured to detect the edge of the sheet extending in the conveyance direction from another detection area of the read image.

6. The image forming apparatus according to claim 1, wherein the edge comprises an edge of the sheet extending in a direction intersecting a conveyance direction in which the conveyor conveys the sheet.

7. The image forming apparatus according to claim 1, wherein the controller is configured to adjust a position of an image to be formed on a sheet by the printer based on the detected edge and the reading result of the chart for adjustment.

8. The image forming apparatus according to claim 1, wherein a position of the second detection area is different from a position of the first detection area.

9. The image forming apparatus according to claim 8, wherein a part of the second detection area overlaps a part of the first detection area.

10. The image forming apparatus according to claim 1, wherein the second detection area is larger than the first detection area.

11. The image forming apparatus according to claim 1, wherein the conveyor comprises an auto document feeder including a sheet feeder on which the sheet is to be placed and a sheet discharge portion to which the sheet conveyed from the sheet feeder by the conveyor is to be delivered.

12. The image forming apparatus according to claim 1, wherein the controller is configured to acquire a thumbnail image showing a reading result of the sheet, estimate a position of a corner portion of the sheet based on the thumbnail image, and set, in the read image, the first detection area at a position spaced apart from the estimated position of the corner portion by a first distance.

13. The image forming apparatus according to claim 12, wherein the controller is configured to set, in the read image, the second detection area at a position spaced apart from the estimated position of the corner portion by a second distance longer than the first distance.

14. An image reading apparatus comprising:
a reading sensor configured to output a read image obtained by reading a chart for adjustment on a sheet; and
a controller configured to:
detect an edge of the sheet from a first detection area of the read image; and
detect the edge of the sheet from a second detection area different from the first detection area of the read image in a case where the edge is not detected from the first detection area.

15. A detection method for a deviation amount of a printing position to be executed by an image forming apparatus including a printer configured to print a chart for adjustment on a sheet, a conveyor configured to convey the sheet, and a reading sensor configured to read the sheet while the sheet is being conveyed by the conveyor, and output a read image of the sheet, the detection method comprising:
detecting an edge of the sheet from a first detection area of the read image;
detecting the edge of the sheet from a second detection area different from the first detection area of the read image in a case where the edge is not detected from the first detection area; and
adjusting an image to be formed on a sheet by the printer based on the detected edge and a reading result of the chart for adjustment.
